(19) United States
(12) Patent Application Publication
(10) Pub. No.: US 2024/0078760 A1
(43) Pub. Date: Mar. 7, 2024

(54) SYNCHRONISED REALITY

(71) Applicant: Samantha Anne Hemingway, Los Angeles, CA (US)

(72) Inventor: Samantha Anne Hemingway, Los Angeles, CA (US)

(73) Assignee: Samantha Anne Hemingway, Los Angeles, CA (US)

(21) Appl. No.: 17/902,294

(22) Filed: Sep. 2, 2022

(51) Int. Cl. G06T 19/00; H04N 21/2187

(52) U.S. Cl. CPC G06T 19/006; H04N 21/2187

(57) ABSTRACT

A laptop cooling pad having one or more heat-dissipating fans adjustable in position is disclosed with a cooler circulating cool air to the pad in question. The laptop cooling pad is provided with a ventilation portion so that a heat-dissipating fan can be mounted on the ventilation portion through a fan support. The ventilation portion has a groove for receiving coolant through the radiator so cool air can circular using fan support to move the heat-dissipating fan inside the laptop cooling pad and make the heat-dissipating fan close to a heat source, thereby ensuring the heat-dissipating effect of the laptop cooling pad. With an added function of a cooler air to be flown through specific pipes and ventilation systems. The utility model discloses a laptop cooler which comprises an upper cover plate, a bottom plate, a support, a fan, a refrigerating machine, a condenser pipe, aluminum sheets, an exhaust fan and a slide track, wherein the refrigerating machine is arranged on and attached to the bottom plate and is connected with the condenser pipe; the condenser pipe is located below the fan; the aluminum sheets parallel to a cross section of the condenser pipe are arranged outside the condenser pipe; the slide track is arranged on the upper cover plate matched with the bottom plate; the exhaust fan is arranged on the slide track; and the support is arranged below the bottom plate. The laptop cooler can blow out cold air, air movement in a laptop is accelerated, the cooling efficiency of the laptop is accelerated, and the service life of the laptop is prolonged.

### FIELD OF THE INVENTION

The present invention relates to a multi-directional live stream video projection for live performances from multiple angles.

### BACKGROUND OF THE INVENTION

The invention itself a platform called Synchronized Reality that can Multi-directionally live stream video between two or more venues so a performer in one venue can be seen in the other while also seeing the crowd in both, all in real time. Four HD cameras film the performer (one from each angle) and are live streamed to the second venue. The video signals are projected onto an inverted pyramid of mirrors, recreating the artist's likeness in a kind of “Digital Twin”. Video of the audience in the second venue is similarly live streamed back to the performer's venue and projected onto the walls. Digital Twin Artists and Synchronised Reality mainly refers to the proprietary technology methodology of transmitting a live performance to simulate that performance or performer in 1 or more remote locations. The specifics of the receiving end are open to multiple formats such as Digital Twin (Hologram) in a venue, theatre, stage, VR, Mobile, Digital platforms ie; Social media Facebook Instagram, Clubhouse, Gaming etc. The Digital Twin content and datasets are retained as a Digital Twin/NFT of the performer and or environment and re-produced again at a later date, as a reimagined live performance or solo Digital Twin performer's artist moment-in-time dataset; an NFT.

Digital Twin Artists (DTA)

A Digital Twin is the generation or collection of digital data representing a physical object/Artist. The concept of digital twin has its roots in engineering and the creation of engineering drawings/graphics.

Synchronised Reality (SR)

Synchronised Reality is the concept of having an Ultra-Low Latency connection between two or more physical immersive or digital environments that allow realities to be synchronized such as they appear to be one. The invention features pyramid shaped light sculpture, hardware asset that creates the Digital Twin, it has angels that are built to a certain degree. It has certain mirrored glass with dusted vinyl or mylar coating to stop a double reflection feedback and noise. The camera's we use to film, are 4-8K the highest resolution, which are required to film the performer, we also use drones or 360 USB tiny camera's to film a full spectrum visual of the performer and also for a 360 coverage of the environment and/or crowd as we ‘map’ in real-time to the receiving venue, Pyramid, theatre, dome etc.

### ACCOMPANYING DRAWING EXPLANATION

FIG. 1 is structural representation of the present utility model in operation.

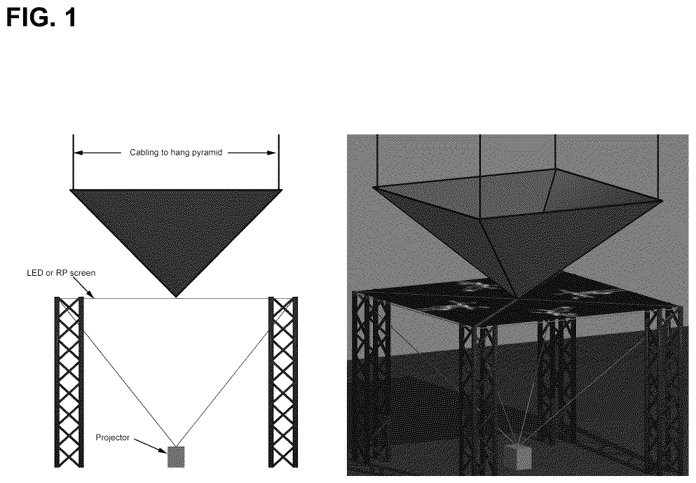

FIG. 2 is an illustration of the camera video layout of view of the invention in operation.

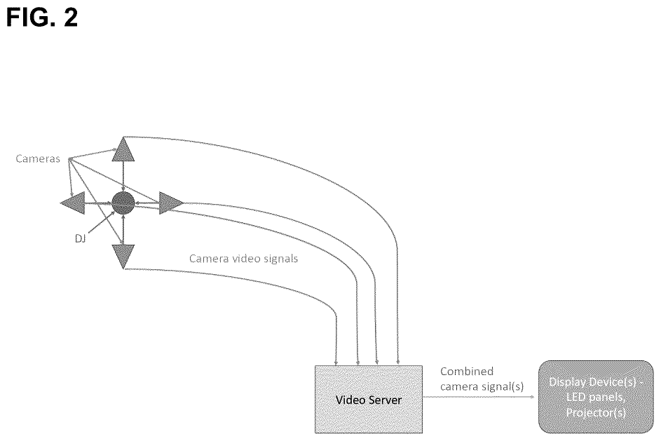

What is claimed is:

1. A Synchronized Reality that can Multi-directionally live stream video between two or more venues so a performer in one venue can be seen in the other while also seeing the crowd in both, all in real time. Four HD cameras film the performer (one from each angle) and are live streamed to the second venue.

2. Further to claim 1, video signals are projected onto an inverted pyramid of mirrors, recreating the artist's likeness in a kind of “Digital Twin”. Video of the audience in the second venue is similarly live streamed back to the performer's venue and projected onto the walls. Digital Twin Artists and Synchronised Reality mainly refers to the proprietary technology methodology of transmitting a live performance to simulate that performance or performer in 1 or more remote locations.

3. Additionally, specifics of the receiving end are open to multiple formats such as Digital Twin (Hologram) in a venue, theatre, stage, VR, Mobile, Digital platforms ie; Social media Facebook Instagram, Clubhouse, Gaming etc. The Digital Twin content and datasets are retained as a Digital Twin/NFT of the performer and or environment and re-produced again at a later date, as a reimagined live performance or solo Digital Twin performer's artist moment-in-time dataset; an NFT.
